(19) United States
(12) Patent Application Publication
(10) Pub. No.: US 2009/0160627 A1
(43) Pub. Date: Jun. 25, 2009

(54) POWER LINE COMMUNICATON FOR ELECTRICAL FIXTURE CONTROL

(75) Inventor: Kedar Godbole, San Jose, CA (US)

Correspondence Address: CYPRESS SEMICONDUCTOR CORPORATION, 198 CHAMPION COURT, SAN JOSE, CA, 95134-1709, US

(73) Assignee: CYPRESS SEMICONDUCTOR CORPORATION, San Jose, CA (US)

(21) Appl. No.: 12/269,863

(22) Filed: Nov. 12, 2008

Related U.S. Application Data
(60) Provisional application No. 61/015,702, filed on Dec. 21, 2007.

(51) Int. Cl. G05B 11/01

(52) U.S. Cl. 340/310.11

(57) ABSTRACT

We disclose an apparatus capable of receiving control command data for one or more electrical fixtures and modulating an alternating current by modifying firing phase angles to transmit the data corresponding to the control commands via a power line transmitting the alternating current.

### RELATED APPLICATIONS

This application claims priority from U.S. Provisional Application No. 61/015,702, filed Dec. 21, 2007 and incorporated herein by this reference in its entirety.

### TECHNICAL FIELD

The present invention relates generally to electronic circuits and in particular to circuits for power line communication.

### BACKGROUND OF THE INVENTION

Various modes of communication are currently used to control electrical fixtures. Commonly, implementation of these communication techniques requires a significant financial investment in hardware and infrastructure. A classic form of electrical fixture control technology is the thyristor (e.g., TRIode for Alternating Current (Triac)) based dimmer. Such dimmers control the intensity of incandescent bulbs by switching power on and off to the bulb very quickly. Because the switching happens very fast, most people do not detect that the light is flickering. Instead, it appears the bulb is dimmer. Thyristor dimmer circuitry and associated hardware is already wired into many homes and offices. However, such dimmers do not work well for light emitting diode (LED) lights, which use different dimming techniques. For example, incandescent bulbs can tolerate dramatic spikes in current while LEDs require very specific power levels to operate.

### BRIEF DESCRIPTION OF THE DRAWINGS

FIG. 1 is a graph of an alternating current sine wave depicting a modified firing phase angle φ.

FIG. 2 illustrates one embodiment of an electronic circuit for controlling an electrical fixture.

FIG. 2a illustrates one embodiment of an electronic circuit for controlling an electrical fixture.

FIG. 3 is a block diagram illustrating one embodiment of a power line communication system for controlling a series of LEDs.

FIG. 4 illustrates one embodiment of a process for transmitting data via a power line.

### DETAILED DESCRIPTION

In the following detailed description, numerous specific details are set forth to provide a thorough understanding of claimed subject matter related to power line communication control for electrical fixtures. However, it will be understood by those skilled in the art that claimed subject matter may be practiced without these specific details. In other instances, well-known methods, procedures, and components have not been described in detail so as not to obscure claimed subject matter.

Disclosed herein is a device and method for communicating control data over a power line to control downstream electrical fixtures. In various embodiments the control data is communicated as firing phase angles on an alternating current (AC). A firing phase angle represents the portion of an AC sine wave “cutoff” by a firing phase angle control circuit. The firing phase angle is controlled by triggering a thyristor coupled to the power line to conduct the AC only at certain points on the AC sine wave. Thus, the AC is chopped up because some portions of the AC sine wave are not conducted or are cutoff by the thyristor. The measure of the portion of the AC sine wave that is cutoff is referred to as the firing phase angle. For instance, if the firing phase angle is 10°, the thyristor will be triggered to conduct the AC after the phase of the AC sine wave reaches 10°. Such firing phase angle control circuits are commonly used in dimmer switches to control the amount of current delivered to a load. The greater the portion of the AC sine wave cutoff the less current delivered to the load. Firing phase angles can be detected by a variety of mechanisms discussed in greater detail herein. Detection of the firing phase angles communicated via the power line enables a remote receiver to decode the control data for controlling the electrical fixtures from the firing phase angles.

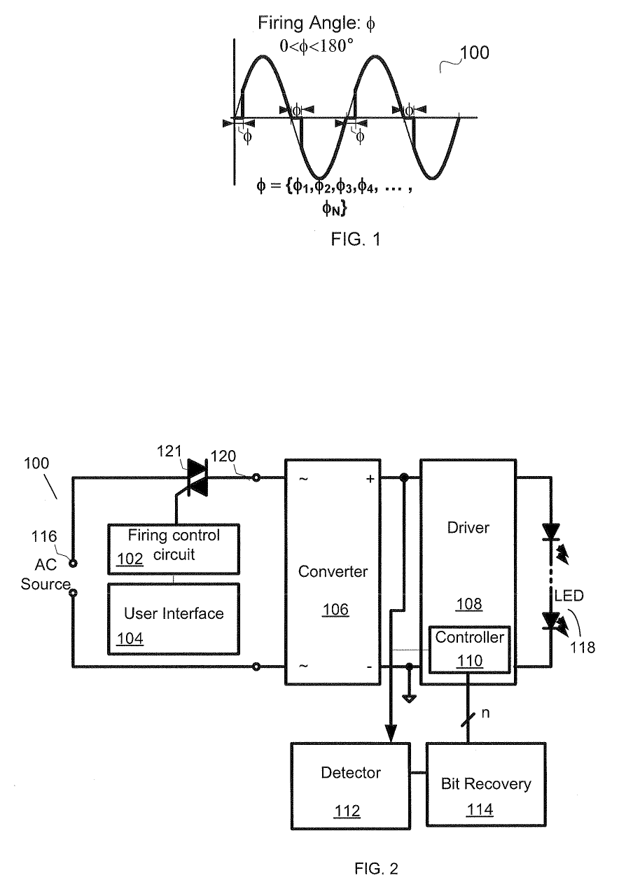

FIG. 1 illustrates an AC sine wave 100 comprising a modified firing phase angle φ. Modifying the firing phase angle φ of an AC source enables controlling the amount of energy delivered to a load because the energy is inversely proportional to the firing phase angle. Thus, triac dimmers control the intensity of incandescent lights by controlling the firing phase angle of the AC source.

A firing phase angle may be modified by a variety of methods. In one embodiment, a firing phase angle control circuit modifies the firing phase angle of an AC. Such a control circuit comprises a variable resistor, firing capacitor and a thyristor (or ‘Triac’) and operates by triggering the thyristor at certain points in the alternating current sine wave cycle. The thyristor cannot conduct until a pulse is delivered to its gate. During each half cycle of the alternating current sine wave, a firing control circuit delivers a pulse to the thyristor gate, turning on the thyristor. The energy delivered to the load is controlled by controlling the firing phase angle φ. The greater the portion of the sine wave coupled to the load, the greater the energy delivered. The zero crossing events happen two times per sine wave cycle. The firing phase angle may be varied from 0° for maximum power to 180° for minimum power delivery.

In the control circuit, when the AC reverses direction there is zero voltage through the thyristor and the thyristor turns off. The thyristor will begin to conduct non-zero AC when triggered by the pulse sent from a firing capacitor. The discharge causes the thyristor to conduct the remainder of the phase or half-cycle of the alternating current until the AC again changes direction and goes through zero turning the thyristor off. The capacitor may be coupled to the variable resistor which may be adjusted to increase or decrease resistance to the current in the line entering the firing capacitor. When enough charge builds up on the firing capacitor it sends the pulse to the thyristor. The more resistance in the line, the longer the capacitor takes to charge and thus the greater the firing phase angle. The firing phase angle controls energy flow in the dimmer circuit. In an embodiment, modification of the firing phase angle of an AC source enables carrying information in the power line.

In one embodiment, firing phase angles of an AC source are modified to enable communication of data in a power line to control a downstream electrical fixture. Control data is mapped to specific firing phase angles, e.g., the set of 5°, 10°, 15° and 20°. Downstream circuitry, e.g., an analog or digital timer unit, or a timing mechanism on a microcontroller or microprocessor, measures the firing phase angles and derives one or more predetermined data bits associated with the measured firing phase angle. In one embodiment, a table in memory includes an association of firing phase angles to data bits, or of firing phase angles to specific commands. A person of ordinary skill in the art will recognize that there are many other possible mechanisms to convert the firing phase angle to a number of bits and claimed subject matter is not limited in this regard.

In one embodiment, the firing phase angle information comprises a particular number of bits. For instance, a set of four firing phase angles such as the set of firing phase angles {5°, 10°, 15° and 20°} may encode two data bits. A reconstruction of these data bits may be obtained by using a suitable mechanism for stacking data bits such as a shift register. Once the shift register accumulates a predetermined number of bits constituting a byte for example, a microprocessor or microcontroller reads the byte. Once the byte is read the microprocessor further processes the information.

In another embodiment, a microprocessor interprets successive data bits as bytes, and then interprets successive data bytes as a data packet. This packet is then decoded in order to obtain information regarding the attributes of the LED display, lighting arrangement and/or other electrical fixture to be controlled. The microcontroller, then implements the control commands using the incoming data. In one embodiment, the incoming data is used to set parameters of an LED light output such as intensity, color co-ordinate and/or other attributes.

In one embodiment, firing phase angles representing control data may range over the entire half-cycle of the AC from 0° to 180° or may range within a smaller portion of the half-cycle, such as between 0° to 30°.

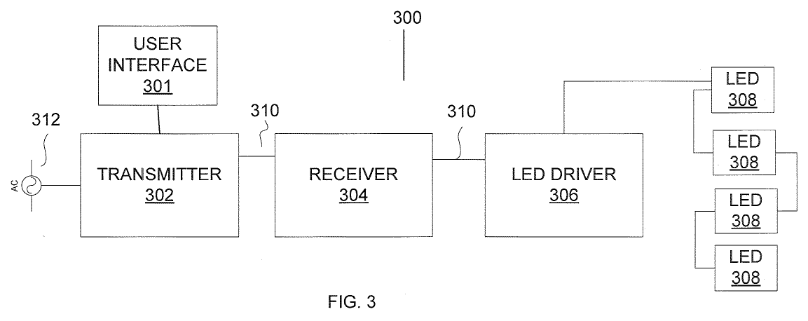

Controlling the firing phase angle range enables communication of data over the power line, while minimizing the effects on the power factor of the downstream fixture being controlled (power factor requirements are discussed in greater detail with respect to FIG. 3). In one embodiment, the microcontroller maintains the previous command even when the encoded data stream is no longer present on the power line. This feature can implement a high power factor when communication is not active.

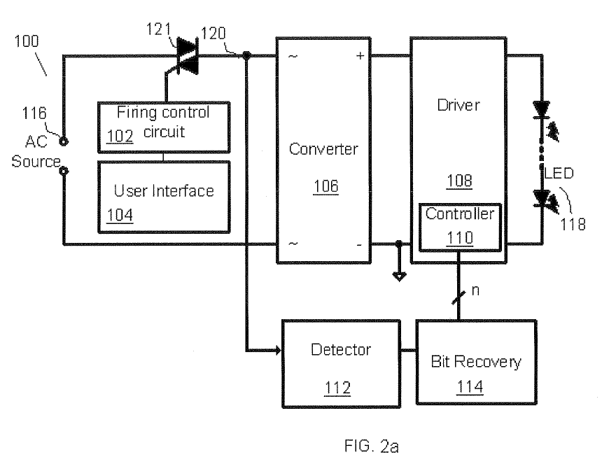

FIG. 2 illustrates one embodiment of a power line communication circuit 100 that can be superimposed into an existing household or office dimmer circuit. Circuit 100 enables communication of electrical fixture control commands from a user interface 104 to a device driver 108. In one embodiment, an AC source enters circuit 100 at node 116 and flows to Triac 121. The firing control circuit 102 varies the firing phase angles of the AC source. In one embodiment, the firing phase angle varies within a discrete range; in another embodiment, the firing phase angle varies over the entire half-cycle of the AC source. The AC source is provided to node 116 as a voltage or current.

In one embodiment, electrical fixture control commands are communicated via a power line to control one or more downstream electrical fixtures 118. Electrical fixture control commands may comprise commands associated with a variety of electrical fixture operations. Such operations may comprise altering timers, changing camera angles, on/off control, changing light intensity and color, increasing or decreasing room temperature, changing audio volume and/or activating an alarm system and claimed subject matter is not limited in this regard.

In one embodiment, firing control circuit 102 is in communication with user interface 104. User interface 104 is operable to receive user input indicating electrical fixture control commands and translates the commands into data to be transmitted in the form of predetermined firing phase angles. In one embodiment, user interface 104 serializes the data and breaks it into one or more blocks comprising one or more firing phase angles representative of n bits. The user interface 104 maps the n bits to a set of firing phase angles. The firing control circuit 102, in turn, encodes the firing phase angles onto the incoming AC. Thus, the firing control circuit 102, encodes the user's commands by varying the firing phase angle of the AC to communicate them to a downstream electrical fixture via a power line 120. In one embodiment, the firing control circuit 102 encodes the AC with the data bits according to a specified set of firing phase angles. However, this is merely an example of a method of receiving and translating data to be encoded on an AC by modifying firing phase angles and claimed subject matter is not so limited.

In one embodiment, the firing phase angle control circuit 102 and user interface 104 are a single unit rather than separate units. In another embodiment, firing control circuit 102 receives user input from user interface 104 directly and processes the commands to serialize and map the data to be transmitted. In yet another embodiment, the user interface 104 transmits data or commands preset by the manufacturer for particular implementations.

In particular embodiments, the user interface 104 may comprise a variety of input devices such as knobs, buttons, keyboards, key pads, personal computers, wireless mobile devices, switches, voice recognition modules and/or touch screens and claimed subject matter is not limited in this regard. In one embodiment, user interface 104 comprises a microprocessor (not shown) for processing user input, for instance, to serialize and/or map data for transmission. In another embodiment, the user interface 104 receives user input and communicates it without processing to the firing control circuit 102. For instance, if firing control circuit 102 is a variable resistor device or potentiometer, a user may simply move a lever or turn a knob and change the resistance to AC entering Triac 121. The firing control circuit 102, in turn, translates the resistance to one or more firing phase angles.

In one embodiment, the firing control circuit 102 modulates the AC with one or more sets of firing phase angles representing one or more values to be encoded. The parameters of a firing phase angle set such as set length and contents may be defined by a variety of protocols and claimed subject matter is not limited in this regard.

In one embodiment, the modulated AC may flow via power line 120 to converter 106. Converter 106 may convert the modulated AC to a pulsating direct current (DC). Such a converter 106 may comprise a variety of devices such as a bridge rectifier and claimed subject matter is not limited in this regard.

According to one embodiment, the pulsating DC may flow to detector 112. A detector 112 may comprise a variety of devices operable to detect firing phase angles of the pulsating DC (either voltage or current) after the pulsating DC leaves converter 106. For instance, detecting devices may comprise a timing unit coupled to a microcontroller, or microprocessor unit and/or a zero detector and claimed subject matter is not limited in this regard. A configurable product such as a Programmable System-On-Chip may also be used to implement the microcontroller functions. Such a microcontroller unit operates by measuring the time between the zero crossings on the DC line, and the instant when the Triac fires, as indicated by the sudden increase in the voltage on the DC line. Referring to FIG. 2a, in an alternate embodiment, detector 112 may be coupled directly to power line 120, and is operable to detect the firing phase angle from the AC line prior to conversion to DC through converter 106.

According to one embodiment, bit recovery unit 114 may be part of detector 112 or may be a separate unit. The detector 112 communicates the detected firing phase angles to the bit recovery unit 114 by a variety of methods known to those of skill in the art and claimed subject matter is not limited in this regard. The bit recovery unit 114 may decode the firing phase angles to one or more data bits, e.g., by accessing a table stored in memory.

In one embodiment, the bit recovery unit 114 communicates the decoded data bits to a controller unit 110. The controller unit 110 processes the data bits to derive control commands that it uses with driver 108 to control the LED fixture 118. In one embodiment, controller 110 comprises a variety of devices such as for instance a microcontroller and/or a PSoC and claimed subject matter is not limited in this regard.

The driver 108 controls various operations of the electrical fixture 118 and executes the electrical fixture control commands transmitted from a user input device 104 via power line 120. However, this is merely an example of an electronic circuit for communicating electrical fixture control commands from a user input device to a fixture and claimed subject matter is not limited in this regard.

FIG. 3 illustrates one embodiment of a power line communication system 300 for communicating control command signals to a light emitting diode (LED) array. In one embodiment, system 300 comprises AC source 312, power line 310, user interface 301, transmitter 302, receiver 304, LED driver 306 and a plurality of LEDs 308 connected in series to form an LED array. In another embodiment, LEDs 308 may be connected in parallel.

In one embodiment, a user may input electrical fixture control commands via user interface 301. In another embodiment, user interface 301 may comprise a microprocessor operable to be preprogrammed to transmit electrical fixture control commands at predetermined times or based on predetermined triggers, e.g., sensing ambient temperature has dropped below a threshold value.

In yet another embodiment, the user interface 301 is coupled to or comprises one or more sensors and is operable to transmit electrical fixture control commands based on detection of a variety of variables. For instance, temperature control commands may be sent in response to detecting a change in ambient temperature and/or light intensity control commands may be sent in response to detecting a change in ambient light intensity and claimed subject matter is not limited in this regard.

In one embodiment, the user interface 301 maps control commands and other data for transmission via the power line 310 to one or more firing phase angles. Transmitter 302 receives the firing phase angle modification instructions from user interface 301. An AC source 312 is coupled to transmitter 302 to supply an AC signal (e.g., voltage or current). Transmitter 302 comprises a firing phase angle control circuit (not shown) that modulates one or more firing phase angles to encode the data onto the AC.

In one embodiment, transmitter 302 transmits the data downstream via power line 310 to receiver 304 where the modulated signal is received and demodulated to decode the transmitted data bits. The receiver 304 communicates data bits to LED driver 306. The LED driver 306 comprises a micro-processor and/or PSoC for processing the data bits to derive electrical fixture control commands to operate LEDs 308. The firing phase angle may be filtered by an analog or digital filter to prevent noise or jitter from generating distortion in the circuit. In one embodiment, an analog filter is located in the receiver 304. In another embodiment, a digital filter is located in LED driver 306.

In one embodiment, LED driver 306 executes electrical fixture control commands. Such control commands may comprise instructions for any of a variety of LED operations. Such operations may include controlling color, light intensity, on/off timing and/or positioning and claimed subject matter is not limited in this regard.

System 300 is further operable to minimize effects on a power factor of LEDs 308. Power factor is a measure of the ratio of the real power to the apparent power and may be represented by a number between 0 and 1. The lower the power factor, the greater the power loss is in the transmission line. Power losses increase power consumption making running low power factor devices costly. Electrical fixtures having a power factor closer to 1 are desirable.

As the firing phase angle increases the power factor decreases. Minimizing the firing phase angle during power line communications may enable powering electronic devices without incurring large power losses. According to one embodiment, the LEDs 308 have a power factor in the range of 0.7-0.9. To minimize or prevent further power factor reduction, transmitter 302 may modulate alternating current within a small range of the half-cycle, such as between about 0° to 10°. In this case, the power losses incurred by modulating the alternating current going to LEDs 308 is reduced a negligible amount, such that the regulated current or voltage sources inside the LED fixture may compensate for the variation. This finer grained modulation of the firing phase angle enables AC firing phase angle modulation in electronic devices that have a high power factor requirement such as LEDs 308. In a particular embodiment, power factor correction may also alleviate reduction in the power factor due to AC firing phase angle modulation.

Power line communication as described above is operable on an intermittent basis further improving power factor ratios. For example, an embodiment of firing control circuit 102 (see FIG. 2) employs a microprocessor unit, which transmits an attribute only once after conditions change. A condition change may include, without limitation, a change in the color setting, when changed by the user. Such an intermittent transmission improves the power factor by distorting the voltage and current over the power line for only a very short time.

Fine grain control of AC firing phase angle modulation may enable a reduction in the fluctuation or variation in light output for the LEDs 308. Also, modulation of the firing phase angle within a small range may decrease the harmonic content of the LEDs 308 over LEDs controlled using conventional Triac dimmers. Breaking up the AC may reduce or otherwise alter the electromagnetic interference signatures of system 300 and may reduce interaction between multiple LED controllers, if any.

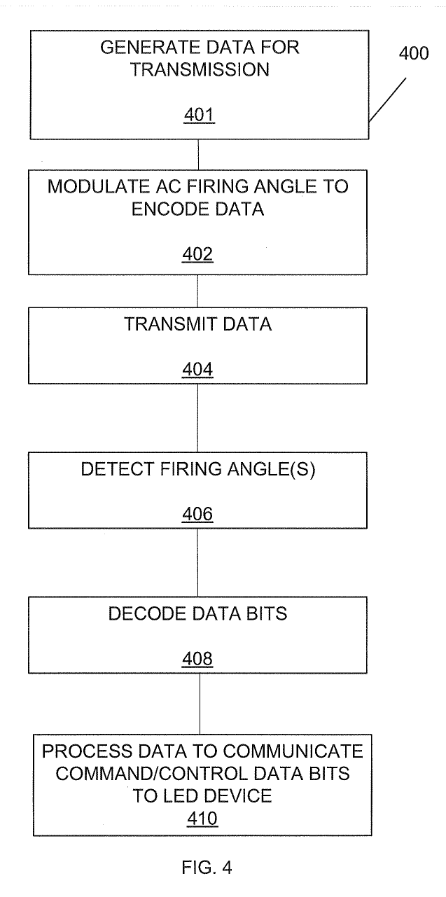

FIG. 4 illustrates an embodiment of a process 400 for communication via a power line. Process 400 begins at block 401 where a user and/or a preprogrammed device may generate command control data for transmission to an electronic device via a power line. At block 402, the data is encoded on an alternating current by varying the firing phase angles of the alternating current. Data is encoded by modulating a single firing phase angle and/or by modulating sets of firing phase angles to send control data.

Process 400 flows to block 404 where the data is transmitted via the AC to a firing phase angle detection unit. At block 406 firing phase angles are detected by a variety of methods such as for instance by measuring zero crossings and/or by measuring timing and claimed subject matter is not limited in this regard. In one embodiment, the detection unit detects firing phase angles on an AC line prior to conversion to DC. In another embodiment, the detection unit detects firing phase angles on a DC line after the AC passes through a converter unit and claimed subject matter is not limited in this regard.

Process 400 flows to block 408 where bit values corresponding to the detected firing phase angles are derived by a variety of demodulation techniques and are communicated to a controller. At block 410, data is processed by the controller to decode data bits and map the data bits to specific commands. The specific commands and attendant control signals are communicated to the LED fixture to control the LEDs 308.

Embodiments of the present invention are well suited to performing various other processes or variations of the process recited herein, and in a sequence other than that depicted and/or described herein. In one embodiment, such a process is carried out by processors and other electrical and electronic components, e.g., executing computer readable and computer executable instructions comprising code contained in a computer usable medium.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

We claim the following.

1. A system comprising:
an interface operable to receive one or more control commands associated with one or more firing phase angles of an alternating current;
a firing phase angle control circuit operable to modulate the alternating current with the one or more firing phase angles;
a detector operable to detect the one or more firing phase angles modulated on the alternating current;
a bit recovery unit operable to derive n data bits associated with the detected one or more firing phase angles;
a processor operable to process the n data bits to derive the one or more control commands; and
a device operable to execute instructions to control one or more electronic fixtures based at least in part on the one or more control commands.

2. The system of claim 1 further comprising a converter coupled to the firing phase angle control circuit via a power line where the converter is operable to convert the modified alternating current to a direct current and where the detector detects the one or more firing phase angles from the direct current.

3. The system of claim 1 where the interface is a microprocessor device, potentiometer, resistor or variable resistor, or combinations thereof.

4. The system of claim 2 where the converter is a bridge rectifier.

5. The system of claim 1 where the detector is a zero detector, timer unit, microprocessor, microcontroller, or programmable processor, or combinations thereof.

6. The system of claim 5 where the programmable processor is a Programmable System on a Chip.

7. The system of claim 1 where the one or more firing phase angles are selected from a plurality of predetermined discrete firing phase angles.

8. The system of claim 1 where the one or more firing phase angles are within a predetermined portion of a half cycle of the alternating current where the predetermined portion is less than between 0° to 180°.

9. The system of claim 1 where the interface associates the one or more control commands to the one or more firing phase angles.

10. The system of claim 1 where the processor is a microcontroller or a Programmable System on a Chip, or combinations thereof.

11. The system of claim 1 where the electronic fixture is a; fan, air conditioner, heating unit, incandescent light, light emitting diode (LED), LED array, video recorder, or alarm, or combinations thereof.

12. An apparatus comprising:
an interface operable to map one or more control commands to one or more firing phase angles of an alternating current; and
a firing phase angle control circuit operable to modulate the alternating current on a power line with the one or more firing phase angles to communicate the one or more control commands to one or more electrical fixtures.

13. The apparatus of claim 12 where the one or more firing phase angles are selected from a plurality of predetermined discrete firing phase angles.

14. The apparatus of claim 12 where the one or more firing phase angles are within a predetermined portion of a half cycle of the alternating current where the predetermined portion is less than between 0° to 180°.

15. An apparatus comprising:
a detector operable to detect one or more firing phase angles of an alternating current where the firing phase angles are associated with one or more control commands for controlling one or more electrical fixtures via a power line;
a bit recovery unit operable to derive n data bits associated with the detected one or more firing phase angles;
a processor operable to derive the one or more control commands according to the derived n data bits; and
a device operable to execute instructions to control the one or more electrical fixtures based at least in part on the derived one or more control commands.

16. The apparatus of claim 15 where the one or more electrical fixtures comprise one or more; fans, air conditioners, heating units, incandescent lights, light emitting diodes (LEDs), LED arrays, video recorders, or alarms, or combinations thereof.

17. The apparatus of claim 15 where the device is a driver, where the driver is operable when executing the one or more control commands to change; camera angles, light intensity, light color, room temperature, audio volume, timer settings or alarm settings, or combinations thereof.
